(19) United States
(12) Patent Application Publication
(10) Pub. No.: US 2009/0213350 A1
(43) Pub. Date: Aug. 27, 2009

(54) COHERENCE-REDUCTION DEVICES AND METHODS FOR PULSED LASERS

(75) Inventor: Michael R. Sogard, Menlo Park, CA (US)

Correspondence Address: KLARQUIST SPARKMAN, LLP, 121 SW SALMON STREET, SUITE 1600, PORTLAND, OR, 97204, US

(73) Assignee: Nikon Corporation

(21) Appl. No.: 12/371,887

(22) Filed: Feb. 16, 2009

Related U.S. Application Data
(60) Provisional application No. 61/030,876, filed on Feb. 22, 2008.

(51) Int. Cl. G03B 27/54; G02B 5/02

(52) U.S. Cl. 355/67; 359/599

(57) ABSTRACT

Devices and methods are disclosed for reducing coherence, and thus speckle, of a coherent beam of light. An exemplary illumination device includes a source emitting a pulsed coherent light beam having a transverse spatial coherence length. A deflector positioned in the path spatially displaces a first portion of a beam pulse from a second portion of the beam pulse, where the second portion is later in time than the first portion. A diffuser situated in the path receives the first portion of the beam pulse on a first region of the diffuser and the second portion of the beam pulse on a second region of the diffuser, such that the first and second regions are separated by a distance at least equal to the transverse spatial coherence length.

### CROSS-REFERENCE TO RELATED APPLICATION

This application claims priority to, and the benefit of, U.S. Provisional Application No. 61/030,876, filed on Feb. 22, 2008, incorporated herein by reference in its entirety.

### FIELD

This disclosure is directed to, inter alia, devices and methods for reducing coherence, and hence speckle, in light produced by pulsed laser sources as used, for example, in microlithography.

### BACKGROUND

Current microlithography systems are designed to operate using high-powered laser sources that produce wavelengths in the deep ultraviolet (UV). A common laser source used in these systems is the excimer laser, which is a chemical laser with a high-powered output that is pulsed. Excimer lasers have several disadvantages, including frequent maintenance, high operational costs, large size, and potential safety hazards. Hence, it is desirable to replace excimer lasers in microlithography systems with an alternative laser source. Solid-state lasers represent an attractive option because of their convenience, small size, low cost, and relative safety when compared to an excimer laser. Although the typical wavelength of operation for solid-state lasers is in the infrared, wavelength-conversion elements can be added to the laser system to generate a wavelength in the deep UV, a useful wavelength regime for exposure purposes in microlithography. Unfortunately, due to the relatively high coherence of solid-state lasers, attempts at implementing these sources in conventional microlithography systems typically resulted in uneven illumination caused by speckle and consequently a reduction of lithographic product quality.

In projection microlithography, uniform illumination of the reticle and wafer is essential for creating the high-resolution patterning used in the manufacture of semiconductor chips and other micro-devices. Laser sources alone do not provide such a uniform beam profile across the illumination field; therefore, beam expansion and other optical-processing techniques are typically performed on the beam produced by the laser source. This optical processing is typically performed by an illumination-optical system comprising various optical components that divide and redistribute portions of the beam so as to improve the intensity uniformity.

A laser source with high spatial and temporal coherence, such as a solid-state laser, will produce undesirable speckle and/or fringe patterns when conventional optical methods are employed. In general, speckle is the presence of local intensity fluctuations in the laser beam caused by interference between different parts of the beam. For example, when a coherent laser beam is incident on an optical element such as a lens array, each lens acts as a source for the transmitted light. Wavefronts emanating from each of these sources will interfere with each other as they propagate and will produce a speckle pattern on an incidence surface. Speckle is produced in a similar manner from interference when coherent light is transmitted through or reflected off types of diffusers, where the surface roughness is comparable to the wavelength of the light. Speckle contrast is a numerical description of the relative magnitude of the bright and dark regions in the speckle pattern and is defined to be 100% for a purely coherent source. The presence of speckle in the illumination beam of a microlithography system reduces image resolution, results in poor image registration, and hence reduces the overall performance level of the system, which is unacceptable in high-volume manufacturing.

Speckle contrast can be reduced by averaging multiple speckle patterns. A schematic of a conventional speckle-reduction system 700 is shown in FIG. 7. A laser 702 outputs a coherent laser beam 706 that is incident on and then transmitted through a stationary diffuser 704, producing a diffused beam 708. The diffused beam 708 produces a single speckle pattern with 100% contrast at a detector 710 located downstream of the diffuser 704. Motion of the diffuser 704 causes the speckle pattern to change, and multiple speckle patterns are produced at the detector 710 by rotating or otherwise moving the diffuser 704 relative to the beam 706. The produced speckle patterns are averaged by the detector 710. The detector 710 detects multiple speckle patterns over a pre-set time-frame before the patterns are averaged to determine an output. The speckle contrast of the output varies inversely with the square root of the number of independent speckle patterns that are averaged. Independent speckle patterns are typically speckle patterns that are uncorrelated and that will not interfere with each other. Since a coherent source produces speckle patterns with 100% speckle contrast, approximately 10,000 independent speckle patterns should be averaged to reduce the speckle contrast to 1%, for example. More explicitly, the inverse of the square root of 10,000 is 1 out of a 100 or 1%. For example, a speckle contrast of 1% at the wafer surface in a microlithography system can significantly affect the critical dimensions of small features. In the system 700 of FIG. 7, if the pre-set time-frame of the detector 710 is long enough to allow 10,000 independent speckle patterns to be detected before the patterns are averaged, the speckle contrast of the output would be approximately 1%. If the diffuser 704 is a rotating diffuser, the time-frame of the detector is generally based on the rotational velocity of the diffuser. A speckle contrast of 1% may be acceptable in some applications, but other applications require a higher or lower value of speckle contrast.

If the laser beam 706 is pulsed, each pulse will produce a different speckle pattern at the detector 710. In this case, the pre-set time-frame of the detector 710 should be sufficiently long to allow 10,000 pulses to be detected and then averaged to reduce the speckle contrast of the detector output to 1%, for example. If the conventional system shown in FIG. 7 is used in a microlithography system, lithographic errors due to speckle can be reduced by illuminating each portion of the exposed pattern with many pulses. The speckle contrast on the exposed surface is reduced as the number of illuminating pulses increases. Hence, it is desirable to illuminate the pattern with as many pulses as possible. The conventional method for reducing speckle shown in FIG. 7 would greatly reduce throughput of the microlithography system by substantially increasing exposure time and placing unwanted restrictions on the laser power and on the general operation of the system.

U.S. Pat. No. 4,155,630 to Ih addresses speckle reduction; however, the apparatus and method of Ih are limited to continuous-wave lasers or to lasers that produce long pulses. Also, the Ih system employs piezo-electric crystals for beam-scanning, which are too slow for many current applications, including microlithography.

Therefore, there is a need for improved devices and methods for achieving speckle reduction in light beams produced by coherent sources such as pulsed laser sources.

### SUMMARY

The foregoing need is met by, inter alia, devices and methods as disclosed herein. According to a first aspect of the invention, illumination devices are provided that comprise a laser or other coherent source, a deflector, and a diffuser. In various embodiments of such a device the source emits a pulsed laser beam along a path. The laser beam has a transverse spatial coherence length and comprises a train of multiple beam pulses. The deflector is positioned in the beam path and is configured to displace a first portion of a beam pulse spatially from a second portion of the beam pulse, wherein the second portion is later in time than the first portion. The diffuser is also situated in the path to receive the first portion of the beam pulse on a first region of the diffuser and the second portion of the beam pulse on a second region of the diffuser. The first and second regions are separated by a distance at least equal to the transverse spatial coherence length of the beam. Thus, among various effects, the first and second portions of the pulse produce different respective speckle patterns such as on a surface downstream of the diffuser. In other words, multiple different speckle patterns are produced from the same pulse of coherent light, which reduces the speckle contrast produced by the pulse compared to the respective speckle contrast of the individual speckle pattern. By decreasing the speckle contrast of individual pulses, the overall speckle generated by the pulsed beam itself is reduced, which yields a more diffuse beam. This reduced speckle contrast can be utilized for, inter alia, improved illumination by the beam of a downstream illumination surface or detector.

One way in which the first and second regions of the diffuser can be separated from each other is by moving (e.g., rotating) the diffuser as each pulse is being incident on the diffuser. The degree of speckle-contrast reduction achieved in a given pulse downstream of the diffuser depends upon, for example, the temporal length of the pulse, the coherence of the laser beam, and the movement velocity of the diffuser (e.g., angular velocity of a rotating diffuser).

Certain embodiments include a detector situated downstream of the diffuser. The detector can be used to detect speckle of pulses from the diffuser and to produce a corresponding signal output. The speckle contrast can be reduced by, for example, averaging multiple speckle patterns (e.g., from multiple pulses) incident on the detector during a pre-set time frame. Example degrees of speckle reduction, without intending to be limiting, are 50%, 10%, and 1%.

If the pulsed beam is used for illumination purposes, reducing the rms (root mean square) of the respective speckle for each pulse allows reduction of the number of pulses required for making a desired degree of illumination. Downstream of the device can be an illumination-optical system that receives the pulses from the diffuser and conditions the beam for use in illuminating an object with the pulsed laser beam. The lower the number of pulses per exposure, the lower the exposure dose.

Various device embodiments can further comprise a scan-amplifier situated downstream of the deflector and upstream of the diffuser. The scan-amplifier can be configured as, for example, a near-confocal resonator cavity. In another embodiment the scan-amplifier is effectively configured as a second deflector such as a rotating mirror or electro-optical deflector. The second deflector in such an embodiment works together with the “first” deflector located downstream of the source. The scan-amplifier is useful for, inter alia, increasing the displacement of pulses on the diffuser.

The deflector can be, for example, an electro-optic deflector. In other embodiments the deflector comprises one or more rotating mirrors. In either configuration, a scan-amplifier can be situated downstream of the deflector and configured to operate either independently of or in cooperation with the deflector. In certain embodiments the scan-amplifier encompasses at least a portion of the deflector.

If necessary, certain embodiments can further comprise a wavelength-conversion system, desirably situated downstream of the deflector and upstream of the diffuser. The wavelength-conversion system (e.g., optical parametric oscillator or generator of second or higher harmonics) can be used for shifting the wavelength of light from that of the source to a different wavelength.

Certain embodiments can include multiple (e.g., first and second) diffusers. The first diffuser can be situated upstream of the deflector while the second diffuser is located downstream of the deflector. Multiple diffusers desirably are configured to operate cooperatively such that a second diffuser enhances the speckle-reduction achieved by a first diffuser.

According to another aspect, devices are provided for producing a laser beam exhibiting reduced speckle. An embodiment of the device comprises a laser source emitting a pulsed laser beam along a path, a deflector, and a diffuser, as summarized above. Certain embodiments include multiple deflectors (e.g., two deflectors) to reduce speckle more than otherwise achievable using only one deflector. Multiple deflectors can produce a time-dependent spatial displacement of the pulsed laser beam such that a first portion of a pulse is directed along a first optical path, and a second portion of the pulse is directed along a second optical path. If the deflectors are rotational type, they can be configured to co-rotate, e.g., in mutually opposite directions so as to cause the first and second portions of each pulse are incident on different regions of the diffuser so as to produce different respective speckle patterns. Thus, the speckle produced by each pulse is reduced.

According to another aspect, devices are provided for reducing speckle in a pulsed laser beam having a transverse spatial coherence length. An embodiment of the device comprises a deflector and a diffuser. The deflector is positioned to receive pulses of the laser beam. The deflector and diffuser are as summarized above. A single or multiple deflectors can be used. A deflector can be of a high-speed scanning type, such as (but not limited to) a deflector comprising multiple moving mirrors, an electro-optical deflector in which the incident beam passes multiple times through the deflector, or a deflector that achieves amplification of the deflection angle of light interacting with the deflector.

According to another aspect, microlithography systems are provided. A representative embodiment of such a system comprises an illumination system and an imaging-optical system. The illumination system includes: (a) a laser source emitting a pulsed laser beam having a transverse spatial coherence length and comprising multiple beam pulses, (b) a deflector as summarized above, and (c) a diffuser as summarized above. The imaging-optical system is situated downstream of the illumination system and receives the pulses from the illumination system. The pulses have reduced speckle, as produced by the diffuser, suitable for imaging purposes.

According to yet another aspect, an illumination device is provided that comprises a laser source, a deflector, and a diffuser. The laser source emits a pulsed laser beam having a particular transverse spatial coherence length. The deflector, situated in the path of the laser beam, deflects pulses of the laser beam at a particular angular velocity. The diffuser receives deflected pulses from the deflector. The deflector moves the pulses across the diffuser at a velocity of motion related to the angular velocity. The velocity of motion is such that a mathematical product of the pulse length and the velocity of motion is at least as large as the transverse spatial coherence length.

According to yet another aspect, methods are provided for reducing speckle in a pulsed laser beam. An embodiment of such a method comprises scanning a pulsed laser beam, having a transverse spatial coherence length, across a diffuser at a velocity of motion that is such that a mathematical product of the pulse length and the velocity of motion is at least as large as the transverse spatial coherence length. The pulsed laser beam is diffused using the diffuser.

The foregoing and other objects, features, and advantages of the invention will become more apparent from the following detailed description, which proceeds with reference to the accompanying figures.

### BRIEF DESCRIPTION OF THE DRAWINGS

FIG. 1 is a schematic of a first representative embodiment of a speckle-reducing device comprising a laser source, a deflector system, a diffuser, and a detector.

FIG. 2A is a block diagram of a second representative embodiment of a speckle-reducing device, comprising a laser source, a deflector, and a diffuser.

FIG. 2B is a block diagram of an alternative configuration of the second representative embodiment that reduces displacement of a speckle-reduced beam.

FIG. 3A is a block diagram of a third representative embodiment of a speckle-reducing device, comprising a laser, a deflector, a scan-amplification system, and a diffuser.

FIG. 3B is a block diagram of an alternative configuration of the third representative embodiment that reduces displacement of a speckle-reduced beam.

FIG. 3C is a block diagram of a second alternative configuration of the third representative embodiment.

FIG. 4 is a block diagram of a fourth representative embodiment of a speckle-reducing device, comprising a laser, a deflector system, additional optics, nonlinear elements, and a diffuser.

FIG. 5 is a block diagram of a fifth representative embodiment of a speckle-reducing device, comprising a laser, a deflector system, and a diffuser contained within a microlithography system.

FIG. 6A is an explanatory schematic of a diffusing system comprising a laser, a rotating diffuser, and a detector.

FIG. 6B is an explanatory schematic of a diffusing system comprising a laser, two rotating diffusers, and a detector.

FIG. 7 is a schematic of a conventional diffusing system comprising a laser, a diffuser, and a detector.

FIG. 8 is an elevational schematic diagram showing certain aspects of an exemplary exposure system that includes at least one of the embodiments disclosed herein.

FIG. 9 is a block diagram of an exemplary semiconductor-device fabrication process that includes wafer-processing steps including a lithography step.

FIG. 10 is a block diagram of a wafer-processing process as referred to in FIG. 9.

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” means electrically, electromagnetically, or optically coupled or linked and does not exclude the presence of intermediate elements between the coupled items.

The described systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In the following description, certain terms may be used such as “up,” “down,”, “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

### General Considerations

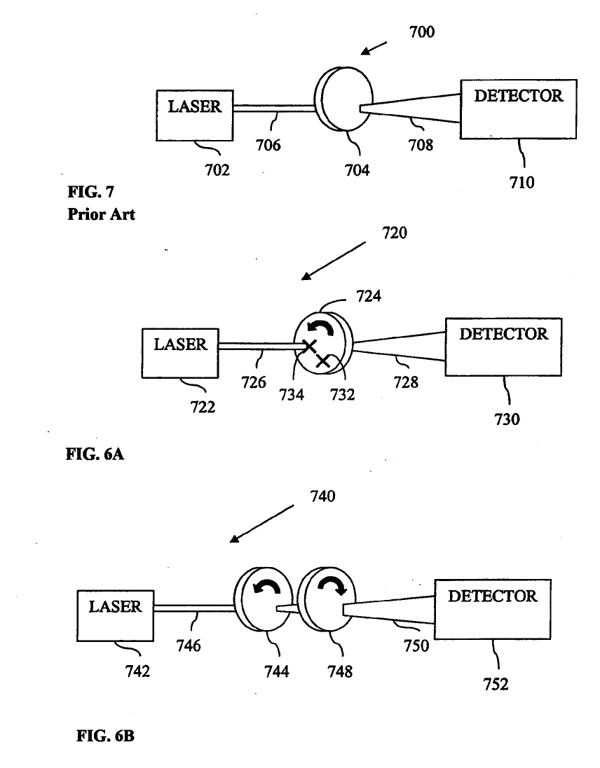

The speckle generated by a pulsed laser beam can be reduced by decreasing the speckle contrast of a speckle pattern produced by a single pulse. For example, a pulse that passes through a diffuser will produce a single speckle pattern when the pulse is incident on a detector or other surface that is downstream of the diffuser. If the diffuser moves or rotates a significant amount between the instant at which a leading edge of the pulse reaches the diffuser and the instant at which a trailing edge of the pulse is incident on the diffuser, these two portions of the pulse will be transmitted through different portions of the diffuser and can produce different speckle patterns at the detector. This method for producing multiple speckle patterns from a single pulse is illustrated in the system 720 of FIG. 6A, in which the laser 722 emits a pulsed coherent laser beam 726 along a path. The beam 726 is incident on and transmitted through a rotating diffuser 724. The beginning portion of a light pulse in the beam 726 is incident on the rotating diffuser 724 at a first point 732, when the first point 732 is in the path of the beam. A later portion of the light pulse is incident on the diffuser 724 at a second point 734, when the second point 734 is in the path of the beam. The now diffused pulse 728 propagates to the detector 730. The beginning portion of the pulse creates a speckle pattern on the detector 730 that is different from a speckle pattern produced by the later portion of the same pulse. When multiple speckle patterns are produced from a single pulse, the speckle contrast produced by the single pulse is reduced from the speckle contrast of each speckle pattern.

For a system such as 720, the speckle contrast of the speckle pattern produced at the detector 730 by each pulse in the beam 726 depends on the length of the pulse, the velocity of rotation of the diffuser 724, and the coherence of the laser beam 726. The contrast of a single pulse can be estimated from the normalized root mean square (rms) noise of the speckle pattern produced by the pulse. The normalized intensity rms value of a speckle pattern produced by a pulse of time duration τ is given approximately as follows:

rms≈[ρ₀/τν]^{1/2} (1)

The relative velocity of the diffuser is ν, and ρₒ is the mean size of the speckle pattern. In this expression, the diffuser is assumed to be moving rapidly enough for substantial reduction of speckle noise, i.e. it is not valid in the limit of ν=0. For an imaging optical system, the mean speckle size is given by the speckle autocorrelation radius. For an optical system with a circular pupil and a numerical aperture of sin α, this is given by ρ₀=1.22λ/2 sin α for light of wavelength λ (Lowenthal and Joyeaux, J. Opt. Soc. America 61:847 (1971)). In general, the relative velocity of a rotating diffuser is calculated from the product of the circumference of the diffuser and the rotations per second of the diffuser. The rms value of the pulse speckle pattern is 1 (unity) when the velocity, ν, of the diffuser is zero. For example, the rms for each pulse speckle pattern produced at the detector 730 is typically 1 (unity) whenever the diffuser 724 in the system 720 is not rotating.

In the diffusing system 720, the speckle contrast of the output of the detector 730 can be reduced when speckle patterns incident on the detector during a pre-set time-frame are summed or averaged. The speckle contrast of the output varies inversely with the square root of the number of independent speckle patterns that are averaged. If the rms value of each pulse speckle pattern is 1 (unity), then the speckle contrast of each pattern is 100%, and 10,000 pulses should be averaged by the detector to reduce the speckle contrast of the detector output to 1%, for example. If the speckle contrast of each pulse is Cp and Cp<1.0, the number of pulses N required to reach a final contrast of C₀ satisfies the relation:

C₀=Cp/N^{1/2}, (3)

leading to the relation,

N=(Cp/C₀)². (4)

If, for example, the rms value is reduced by 50% to a value of 0.5, then only 2500 pulses should be averaged by the detector to reduce the speckle contrast of the detector output to 1%. In general, it is desirable to reduce the rms value of the speckle pattern of each pulse so that a particular speckle contrast value can be achieved with fewer pulses.

For example, in a microlithography system, lithographic errors due to speckle can be reduced by illuminating each portion of an exposed pattern with many pulses containing different speckle patterns. The larger the number of illuminating pulses, the more the speckle contrast is reduced. However, improved throughput of the microlithography system is typically achieved when fewer illuminating pulses are used. A speckle-reducing system that reduces the rms of each pulse speckle pattern is desirable because such a system can reduce the number of illuminating pulses.

As an example, consider a scanning microlithography system that exposes wafers at a wafer-stage scanning velocity of 500 mm/sec using an excimer laser with a repetition rate of 4 kHz. If the resist-coated wafer is exposed through a slit of width 6 mm, measured in the direction of scanning, the number of pulses contributing to the exposure at a given location on the wafer is 6/500×4000=48 pulses. This is much less than the number of pulses discussed above, partly because of conventional speckle-reduction measures provided in the illumination unit of the microlithography system, but also because the excimer laser is typically less coherent than a solid-state laser. Because of its very high specific gain the excimer laser beam is less affected by the optical properties of its cavity and tends to lase in a number of modes simultaneously, which reduces the speckle. A description of coherence considerations in the design of excimer laser illumination systems for microlithography is given in Lin et al., Appl. Opt. 40:1931 (2001).

For a pulsed laser source, increasing the rotational velocity of the diffuser will reduce the rms value according to Equation (1). However, the velocity at which a diffuser can be moved or rotated is physically limited. For the diffusing system 720, the effective rotational velocity of the diffuser 724 can be increased by adding a second, stationary diffuser. This also reduces the speckle rms considerably. An exemplary system 740 with two diffusers 744 and 748 is shown in FIG. 6B. The second diffuser 748 rotates in a direction opposite to that of the first diffuser 744, and the effective rotational velocity of the system is the sum of the respective rotational velocities of the diffusers 744, 748. The normalized intensity rms value of a speckle pattern, or equivalently its contrast, produced by a pulse of time duration τ is given by:

$$rms = \frac{1}{{[ 1 + {{τ}^{2} ( \frac{v}{{ρ}_{o}} )}^{2} ]}^{1 / 4}} \qquad ( 2 )$$

More importantly, as shown in Lowenthal and Joyeaux, referenced above, the value of ρ₀ in Eq. (2) is replaced by the autocorrelation length of the diffuser, which is typically much smaller than the size of the speckle autocorrelation. For example, in the Lowenthal-Joyeaux paper, speckle rms is reduced to approximately 1% by displacing a single diffuser a distance of 77 mm during the pulse duration, assuming λ=0.63 μm and sin α=0.05. They find a similar reduction in speckle rms for a displacement of a diffuser (milk glass—autocorrelation length approximately 0.4 μm) by 4 mm, in front of or behind a second fixed diffuser. This is equivalent to a displacement of both diffusers in opposite directions of 2 mm each. Thus, the double diffuser system is superior to the single diffuser one. Despite this improvement, displacing a diffuser 4 mm during the length of a laser pulse of 10 nsec would require a velocity of 400,000 m/sec.

If the pulse duration is short, the rotational velocities of the diffusers 744, 748 must be very high to reduce significantly the rms of the speckle patterns produced by the pulses from the laser source 742. Solid-state and excimer lasers typically emit pulses of approximately 30 ns or shorter. The system 740 can be impractical for such laser sources due to the required high rotational velocities required of the diffusers.

### First Representative Embodiment

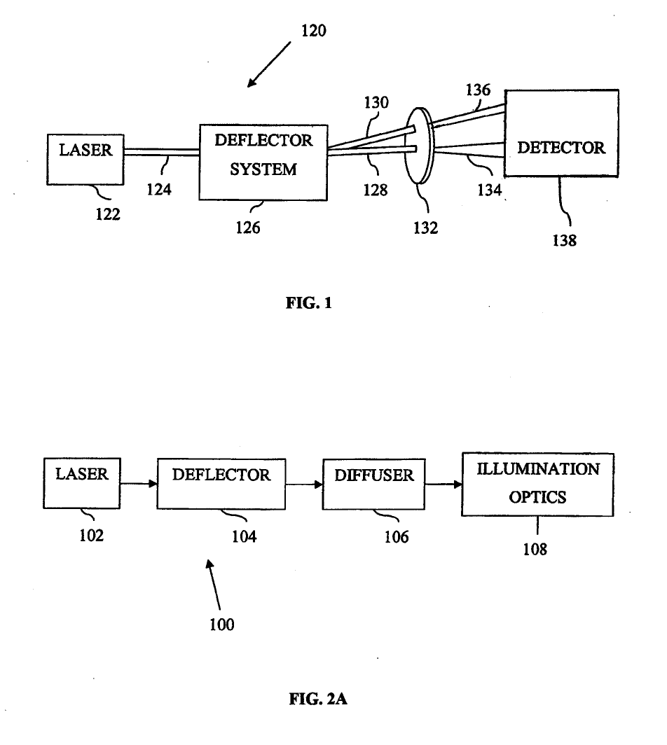

A first representative embodiment of a speckle-reducing device 120 is shown schematically in FIG. 1. The device 120 reduces speckle contrast in a pulsed laser source without being limited by the velocity of motion of a diffuser. In the system 120, a laser source 122 emits a pulsed laser beam 124 along a path. The time duration of the pulses in the beam 124 is denoted τ. The beam 124 has a speckle autocorrelation length ρₒ and is incident on a deflector system 126. The deflector system 126 is a fast beam scanner, deflector, or similar mechanism that creates a time-dependent spatial displacement of the beam 124. The speed of deflection of the deflector system 126 is such that a beginning portion of a pulse in the beam 124 is deflected along a path 128 while a later portion of the pulse is deflected along a path 130. Respective light propagating along the paths 128, 130 is incident at different respective locations on the diffuser 132 and become respective transmitted beams 134, 136. In this manner, the pulses in the system 120 are effectively spread across an area of the diffuser 132. Different portions of individual pulses are incident on different regions of the diffuser 132 and produce different speckle patterns. Hence, the speckle contrast produced by each individual pulse is reduced. With the deflector system 126, it is desirable that the speed of deflection be such that the total displacement of a pulse on the diffuser 132 is equal to or greater than the speckle autocorrelation length of the laser beam 124.

As described above, speckle reduction will be improved with this embodiment, particularly if a stationary diffuser is placed upstream of the deflector system 126.

The rms of a speckle pattern produced by a single pulse at the detector 138 can be determined from Eq. (1), where ν is the velocity of the deflected beam across the diffuser 132. This velocity ν is related to the angular velocity of the deflected beam by the distance between the deflector 126 and the diffuser 132. Reduction in the rms value typically occurs in the system 120 whenever the product of the velocity of the beam across the diffuser and the pulse duration (ντ) is greater than the transverse spatial coherence ρₒ of the beam. However, ντ may be equal to or slightly less than ρₒ in some cases.

Because a beam may be scanned or deflected with any given speed if the distance between the deflector 126 and the diffuser 132 is unlimited, the length of the pulse is not a limiting factor when reducing speckle using the system 120. For deflecting the beam 124, the deflector 126 can be a rotating mirror, a pivoting mirror, an electro-optic deflector, or any other appropriate device. An electro-optic deflector is especially desirable due to the high speed of deflection that can be achieved with such a device. With most deflectors 126, the speed of scanning or deflection can be increased by employing any of various scan-amplification techniques such as, but not limited to, the following: using multiple rotating mirrors, increasing the number of passes through an electro-optic deflector, and amplifying the deflection angle using a scan-amplification system. By way of example, scan amplification achieved using a near-confocal resonator is described in Beiser, J. Appl. Phys. 43:3507-3510 (1972), incorporated herein by reference. This type of amplification system is advantageous because it is passive and can obtain a significant amplification factor.

### Second Representative Embodiment

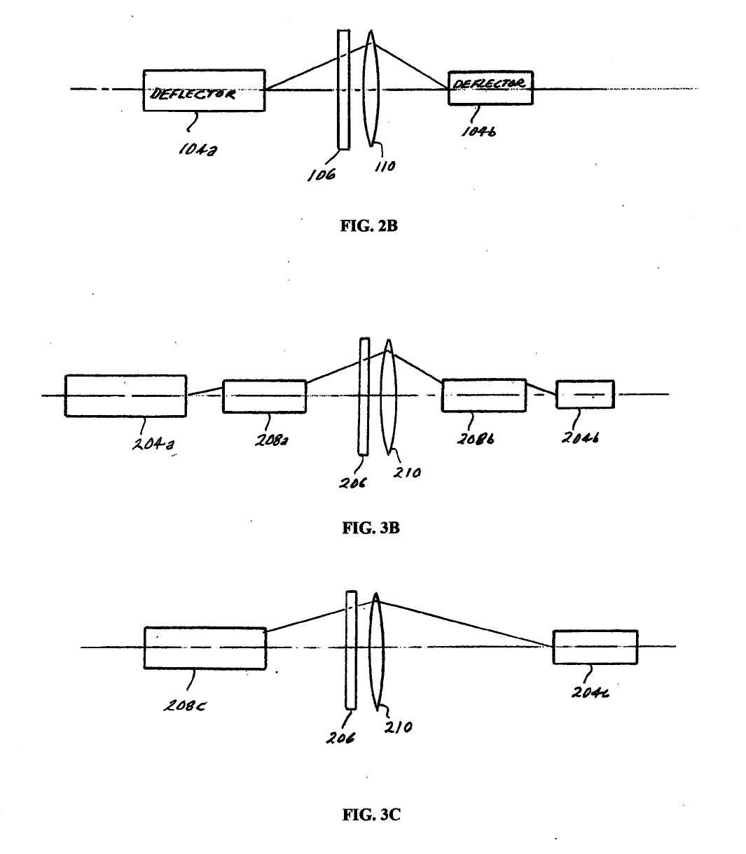

A second representative embodiment of a speckle-reducing device 100 is shown in FIG. 2A. The device 100 includes a laser source 102, a deflector 104, and a diffuser 106. Downstream of the diffuser 106 are optional illumination optics 108. The source 102, deflector 104, diffuser 106, and illumination optics 108 are coupled together in series. The laser source 102 can be a solid-state laser or an excimer laser, for example. The deflector 104 is desirably an electro-optic deflector. Alternatively, the deflector is a rotating mirror when conditions permit lower angular deflection speeds. The diffuser 106 can be any one or more of the following: a phase plate, a ground-glass plate, a fiber bundle, or a holographic diffusing element. Typically, the type of diffuser 106 is selected based on the intended use of the device 100, the wavelength of the source 102, and the desired angular spread of the beam output from the diffuser 106. The illumination optics 108 can comprise lenses, lenses and mirrors, or only mirrors, depending upon the wavelength and application. The device 100 reduces speckle in a pulsed laser beam by the deflector 104 deflecting the laser beam across the diffuser 106 at a sufficiently high angular velocity such that the root mean square (rms) noise of the speckle pattern produced by the pulse is reduced, i.e., such that the total displacement of a pulse on the diffuser is equal to or greater than the speckle autocorrelation length of the laser source.

In FIG. 2A the speckle-reduced beam enters the illumination optics 108 displaced from its position in the absence of the deflector. This displacement may affect the performance of the illumination optics, depending on its design. FIG. 2B shows a means of eliminating this displacement. The diffuser 106 is followed by a lens 110 and a second deflector 104b. The center of deflection of the first deflector 104a and the center of deflection of the second deflector 104b lie at symmetric conjugate points of the lens 110, and the second deflector 104b is operated with the same signal as the first deflector 104a. Thus the speckle-reduced beam is returned to its original trajectory prior to the first deflection.

As described above, speckle reduction can be improved with this embodiment by placing a stationary diffuser upstream of the deflector 104. Alternatively, for the system shown in FIG. 2B, the stationary diffuser can be placed after the deflector 104b.

### Example 1

This example is of the second representative embodiment, in which the laser source 102 is a Q-switched Nd:YAG laser operating at a wavelength of 1064 nm, with a pulse length of approximately 20 ns and a transverse spatial coherence length of 0.5 mm. The deflector 104 is an electro-optic deflector, and the distance between the deflector 104 and the diffuser 106 is 1 m. The electro-optic deflector 104 scans the beam across the diffuser 106 at an angular velocity of approximately 5×10⁴ radians per second. Typically, electro-optic deflectors impose a transverse index-of-refraction gradient across the beam diameter to scan the beam across a downstream surface. Using an electro-optical deflector made from potassium dihydrogen phosphate (KDP), a change in applied voltage of 1000 volts over the 20-ns duration of the pulse provided an angular velocity of deflection of at least 5×10⁴ radians per second. The diffuser 106 in this example is a holographic element. In this example, the contrast of the pulse speckle in the beam is reduced from 1.0 to 0.67. The number of pulses that must be averaged to achieve a desired level of contrast is reduced by the factor (0.67)²=0.45, a reduction of more than a factor of two.

The reduction depends on the relative velocity of the diffuser(s). For example, a rotating mirror producing the same relative velocity would achieve the same reduction of speckle contrast.

### Third Representative Embodiment

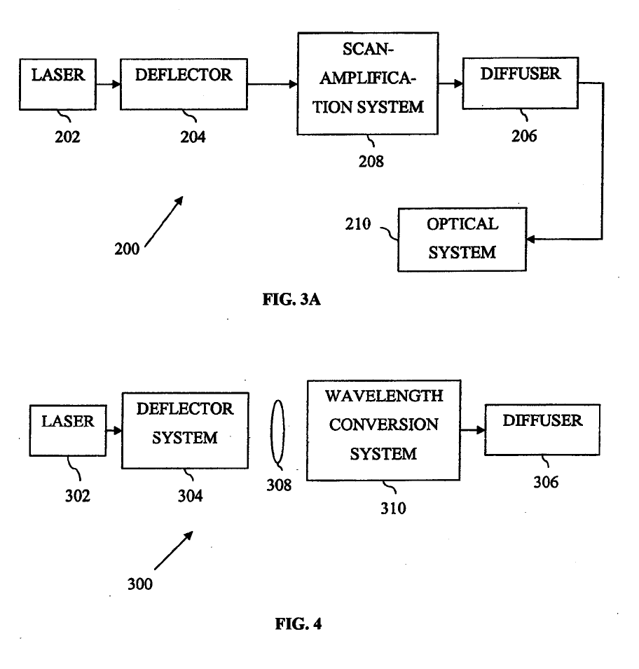

A third representative embodiment of a speckle-reducing device 200 is shown in FIG. 3A. The device 200 includes a laser source 202, a deflector 204, a scan-amplifier 208, a diffuser 206, and an optional optical system 210. The source 202, deflector 204, scan-amplifier 208, diffuser 206, and optical system 210 are coupled together in series. The laser source 202 can be a solid-state laser or an excimer laser, for example. The deflector 204 can be, for example, an electro-optic deflector or a rotating mirror. The scan-amplifier 208 can be, for example, an additional deflector such as a rotating mirror or an electro-optic deflector. Alternatively, the scan-amplifier 208 can be a near-confocal resonator. The scan-amplifier 208 increases the deflection angle over that produced by the deflector 204. The diffuser 206 can be any one or more of the following: a phase plate, a ground-glass plate, a fiber bundle, or a holographic diffusing element. The device 200 operates to reduce speckle in a pulsed laser beam from the source 202 by increasing the effective scan speed of the deflector 204 using the scan-amplifier 208. The effective scan speed is increased such that the laser beam is deflected across the diffuser 206 at a sufficiently high angular velocity that the root mean square (rms) noise of a speckle pattern produced by the pulse is reduced, i.e., such that the total displacement of a pulse on the diffuser is equal to or greater than the transverse spatial coherence length of the laser source.

In FIG. 3A the speckle-reduced beam enters the optical system 210 displaced from its position in the absence of the deflector. This displacement may affect the performance of the optical system 210, depending on its design. FIG. 3B shows means for eliminating this displacement. The diffuser 206 is followed by a lens 207, a second scan-amplifier 208b and a second deflector 204b. The lens 207 is located symmetrically with respect to the deflectors 204a, 204b, and the scan-amplifiers 208a, 208b are located symmetrically with respect to the lens 207. The scan-amplifier 208b is operated with the beam direction reversed from that of the scan-amplifier 208a, so the angle is reduced rather than amplified. The second deflector 204b is operated with the same signal as the first deflector 204a. Thus, the speckle-reduced beam is returned to its original trajectory prior to deflection.

The scan-amplifier system can include the initial deflector. In this case the embodiment can be simplified to that shown in FIG. 3C. The initial beam enters a scan amplification and deflector system 208c, passes through a diffuser 206 and a lens 207, and intercepts the optical axis at the location of a third deflector 204c, where the beam is redirected along the optical axis. The centers of deflection of the scan amplification and deflector system 208c and the deflector 204c lie at conjugate points of the lens 207. The ratio of the image to object distances is equal to the scan-amplification gain. If the scan-amplification gain is greater than 1 (unity), the deflection speed required of the deflector 204c is reduced, and a simple deflector may be adequate.

As described above, speckle reduction will be improved with this embodiment if a stationary diffuser is placed upstream of the deflector system 204. Alternatively, for the systems shown in FIG. 3B or FIG. 3C, the stationary diffuser could also be placed after the deflector 204b or 204c.

### Example 2

In this example of the third representative embodiment, the laser source 202, the deflector 204, and the diffuser 206 are the same as in Example 1. The scan-amplifier increases the deflector angle change by a factor of 5. This is equivalent to increasing the relative velocity of the diffuser 5-fold. The speckle contrast is reduced from 1.0 to 0.315. The number of pulses that must be averaged to achieve a desired level of contrast is reduced by the factor (0.315)²=0.1, a reduction of a factor of ten.

### Fourth Representative Embodiment

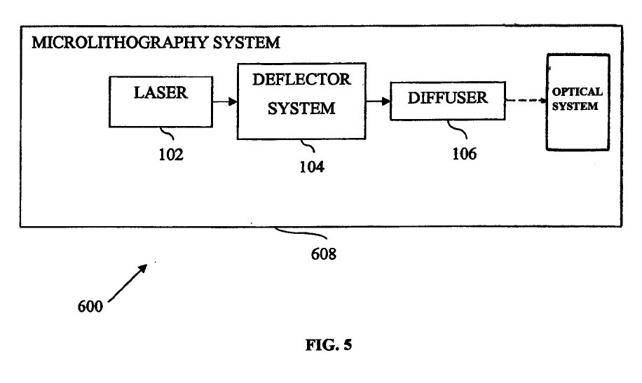

The fourth representative embodiment of a speckle-reducing device 300 is shown in FIG. 4. The device 300 includes a laser source 302, a deflector system 304, a first optical system 308, a wavelength-conversion system 310, and a diffuser 306. Although not shown, a second optical system can be situated downstream of the diffuser 306. The source 302, deflector system 304, first optical system 308, wavelength-conversion system 310, and diffuser 306 are coupled together in series. The laser source 302 can be a solid-state laser or an excimer laser, for example. The deflector system 304 can be an electro-optic deflector or a rotating mirror, for example. The deflector system 304 can also include a system for scan amplification such as additional deflectors or a near-confocal resonator, for example. The optical system 308 can be a single lens or a series of lenses, objectives, and/or mirrors. The wavelength-conversion system 310 can be an optical parametric oscillator or a system for second or higher harmonic generation, for example. The diffuser 306 can be any one or more of the following: a phase plate, a ground-glass plate, a fiber bundle, or a holographic diffusing element. The device 300 operates to reduce speckle in a pulsed laser beam produced by the source 302 and shifts the source wavelength to a desired wavelength using the wavelength-conversion system 310. The angular velocity of the deflector system 304 is such that the root mean square (rms) noise of the speckle pattern produced by the pulse is reduced when transmitted through the diffuser 306. Nominally, the speckle reduction of this system would be expected to be comparable to that of a similar system without a wavelength-conversion system. However, non-linear optical processes tend to increase the coherency of the light, so speckle reduction might be reduced by the process of wavelength conversion. The amount will depend on the details of the wavelength-conversion system.

This embodiment is advantageous for microlithography systems when nonlinear conversion elements are used to shift the wavelength of a long-wavelength source into the UV.

The wavelength-conversion system often requires the beam enter in a specified direction. In this case the optical system 308 can be a lens located a distance, from the center of deflection of the deflector system 304, equal to the back focal length of the lens 308. The deflected beam then enters the wavelength-conversion system displaced but parallel to its original trajectory. After passing through the diffuser 306, a second lens can return the beam to the original optical axis where a second deflector system can return the beam to its original direction. By increasing the focal length of the second lens, the amount of deflection required by the second deflection system can be reduced. A second diffuser can be added downstream of the second deflection system to enhance speckle reduction.

### Fifth Representative Embodiment

A fifth representative embodiment of a speckle-reducing device 600 is shown in FIG. 5. The device 600 includes the components of the second representative embodiment contained within a microlithography system 608. The device 600 operates to reduce speckle of a pulsed laser beam in the microlithography system 608 by deflecting the laser beam across the diffuser 106 at a sufficiently high angular velocity such that the root mean square (rms) noise of a speckle pattern produced by the pulse is reduced.

A speckle-reduction device such as any of those described in the first through the fifth representative embodiments may also be implemented in a metrology, wafer-inspection, imaging, or laser-fusion system.

### Representative Microlithography System

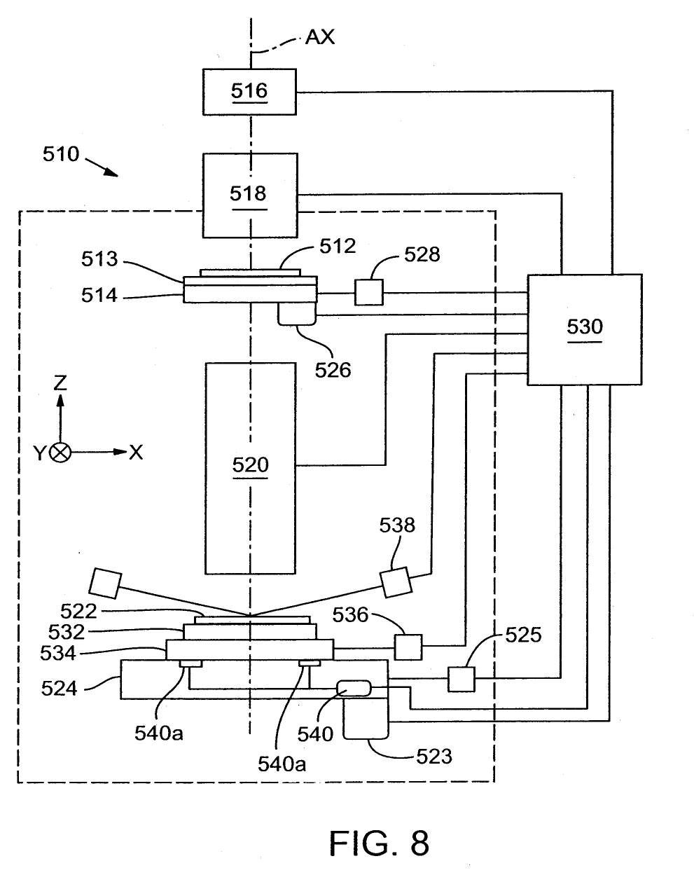

An exemplary microlithography system 510 (generally termed an “exposure system”) with which any of the foregoing embodiments can be used is depicted in FIG. 8, which depicts an example of a projection-exposure system. A pattern is defined on a reticle (sometimes termed a “mask”) 512 mounted on a reticle stage 514. The reticle 512 is “illuminated” by an energy beam (e.g., DUV light) produced by a source 516 and passed through an illumination-optical system 518. As the energy beam passes through the reticle 512, the beam acquires an ability to form an image, of the illuminated portion of the reticle 512, downstream of the reticle. The beam passes through a projection-optical system 520 that focuses the beam on a sensitive surface of a substrate 522 held on a substrate stage (“wafer stage” or “wafer XY stage”) 524. As shown in the figure, the source 516, illumination-optical system 518, reticle stage 514, projection-optical system 520, and wafer stage 524 generally are situated relative to each other along an optical axis AX. The reticle stage 514 is movable at least in the x- and θ_{z}-directions using a stage actuator 526 (e.g., linear motor), and the positions of the reticle stage 514 in the x- and y-directions are detected by respective interferometers 528. Each of the interferometers 528 actually comprises a sufficient number of redundant interferometers to provide respective air-fluctuation monitors as described above. The system 510 is controlled by a system controller (computer) 530.

The substrate 522 (also termed a “wafer”) is mounted on the wafer stage 524 by a wafer chuck 532 and wafer table 534 (also termed a “leveling table”). The wafer stage 524 not only holds the wafer 522 for exposure (with the resist facing in the upstream direction) but also provides for controlled movements of the wafer 522 in the x- and y-directions as required for exposure and for alignment purposes. The wafer stage 524 is movable by a suitable wafer-stage actuator 523 (e.g., linear motor), and positions of the wafer stage 524 in the X- and Y-directions are determined by respective interferometers 525. The wafer table 534 is used to perform fine positional adjustments of the wafer chuck 532 (holding the wafer 522), relative to the wafer stage 524, in each of the x-, y-, and z-directions. Positions of the wafer table 534 in the x- and y-directions are determined by respective wafer-stage interferometers 536. Each of the interferometers 536 actually comprises a sufficient number of redundant interferometers to provide respective air-fluctuation monitors as described above.

The wafer chuck 532 is configured to hold the wafer 522 firmly for exposure and to facilitate presentation of a planar sensitive surface of the wafer 522 for exposure. The wafer 522 usually is held to the surface of the wafer chuck 532 by vacuum, although other techniques such as electrostatic attraction can be employed under certain conditions. The wafer chuck 532 also facilitates the conduction of heat away from the wafer 522 that otherwise would accumulate in the wafer during exposure.

Movements of the wafer table 534 in the z-direction (optical-axis direction) and tilts of the wafer table 34 relative to the z-axis (optical axis AX) typically are made in order to establish or restore proper focus of the image, formed by the projection-optical system 520, on the sensitive surface of the wafer 522. “Focus” relates to the position of the exposed portion of the wafer 522 relative to the projection-optical system 520. Focus usually is determined automatically, using an auto-focus (AF) device 538. The AF device 538 produces data that is routed to the system controller 530. If the focus data produced by the AF device 538 indicates existence of an out-of-focus condition, then the system controller 530 produces a “leveling command” that is routed to a wafer-table controller 540 connected to individual wafer-table actuators 540a. Energization of the wafer-table actuators 540a results in movement and/or tilting of the wafer table 534 serving to restore proper focus.

The exposure system 510 can be any of various types. For example, as an alternative to operating in a “step-and-repeat” manner characteristic of steppers, the exposure system can be a scanning-type apparatus operable to expose the pattern from the reticle 512 to the wafer 522 while continuously scanning both the reticle 512 and wafer 522 in a synchronous manner. During such scanning, the reticle 512 and wafer 522 are moved synchronously in opposite directions perpendicular to the optical axis Ax. The scanning motions are performed by the respective stages 514, 524.

In contrast, a step-and-repeat exposure apparatus performs exposure only while the reticle 512 and wafer 522 are stationary. If the exposure apparatus is an “optical lithography” apparatus, the wafer 522 typically is in a constant position relative to the reticle 512 and projection-optical system 520 during exposure of a given pattern field. After the particular pattern field is exposed, the wafer 522 is moved, perpendicularly to the optical axis AX and relative to the reticle 512, to place the next field of the wafer 522 into position for exposure. In such a manner, images of the reticle pattern are sequentially exposed onto respective fields on the wafer 522.

Exposure systems as provided herein are not limited to microlithography systems for manufacturing microelectronic devices. As a first alternative, for example, the exposure system can be a microlithography system used for transferring a pattern for a liquid-crystal display (LCD) onto a glass plate. As a second alternative, the exposure system can be a microlithography system used for manufacturing thin-film magnetic heads. As a third alternative, the exposure system can be a proximity-microlithography system used for exposing, for example, a mask pattern. In this alternative, the mask and substrate are placed in close proximity with each other, and exposure is performed without having to use a projection-optical system 520.

The principles set forth in the foregoing disclosure further alternatively can be used with any of various other apparatus, including (but not limited to) other microelectronic-processing apparatus, machine tools, metal-cutting equipment, and inspection apparatus.

In any of various exposure systems as described above, the source 516 (in the illumination-optical system 518) of illumination “light” can be, for example, a g-line source (436 nm), an i-line source (365 nm), a KrF excimer laser (248 nm), an ArF excimer laser (193 nm), or an F₂ excimer laser (157 nm). Alternatively, the source 516 can be of any other suitable exposure light.

With respect to the projection-optical system 520, if the illumination light comprises far-ultraviolet radiation, then the constituent lenses are made of UV-transmissive materials such as quartz and fluorite that readily transmit ultraviolet radiation. If the illumination light is produced by an F₂ excimer laser or EUV source, then the lenses of the projection-optical system 520 can be either refractive or catadioptric, and the reticle 512 desirably is a reflective type. If the illumination light is in the vacuum ultraviolet (VUV) range (less than 200 nm), then the projection-optical system 520 can have a catadioptric configuration with beam splitter and concave mirror, as disclosed for example in U.S. Pat. Nos. 5,668,672 and 5,835,275, incorporated herein by reference. The projection-optical system 520 also can have a reflecting-refracting configuration including a concave mirror but not a beam splitter, as disclosed in U.S. Pat. Nos. 5,689,377 and 5,892,117, incorporated herein by reference.

Either or both the reticle stage 514 and wafer stage 524 can include respective linear motors for achieving the motions of the reticle 512 and wafer 522, respectively, in the x-axis and y-axis directions. The linear motors can be air-levitation types (employing air bearings) or magnetic-levitation types (employing bearings based on the Lorentz force or a reactance force). Either or both stages 514, 524 can be configured to move along a respective guide or alternatively can be guideless. See U.S. Pat. Nos. 5,623,853 and 5,528,118, incorporated herein by reference.

Further alternatively, either or both stages 514, 524 can be driven by a planar motor that drives the respective stage by electromagnetic force generated by a magnet unit having two-dimensionally arranged magnets and an armature-coil unit having two-dimensionally arranged coils in facing positions. With such a drive system, either the magnet unit or the armature-coil unit is connected to the respective stage and the other unit is mounted on a moving-plane side of the respective stage.

Movement of a stage 514, 524 as described herein can generate reaction forces that can affect the performance of the exposure apparatus. Reaction forces generated by motion of the wafer stage 524 can be shunted to the floor (ground) using a frame member as described, e.g., in U.S. Pat. No. 5,528,118, incorporated herein by reference. Reaction forces generated by motion of the reticle stage 514 can be shunted to the floor (ground) using a frame member as described in U.S. Pat. No. 5,874,820, incorporated herein by reference.

An exposure system such as any of the various types described above can be constructed by assembling together the various subsystems, including any of the elements listed in the appended claims, in a manner ensuring that the prescribed mechanical accuracy, electrical accuracy, and optical accuracy are obtained and maintained. For example, to maintain the various accuracy specifications, before and after assembly, optical-system components and assemblies are adjusted as required to achieve maximal optical accuracy. Similarly, mechanical and electrical systems are adjusted as required to achieve maximal respective accuracies. Assembling the various subsystems into an exposure apparatus requires the making of mechanical interfaces, electrical-circuit wiring connections, and pneumatic plumbing connections as required between the various subsystems. Typically, constituent subsystems are assembled prior to assembling the subsystems into an exposure apparatus. After assembly of the apparatus, system adjustments are made as required for achieving overall system specifications in accuracy, etc. Assembly at the subsystem and system levels desirably is performed in a clean room where temperature and humidity are controlled.

### Semiconductor-Device Fabrication

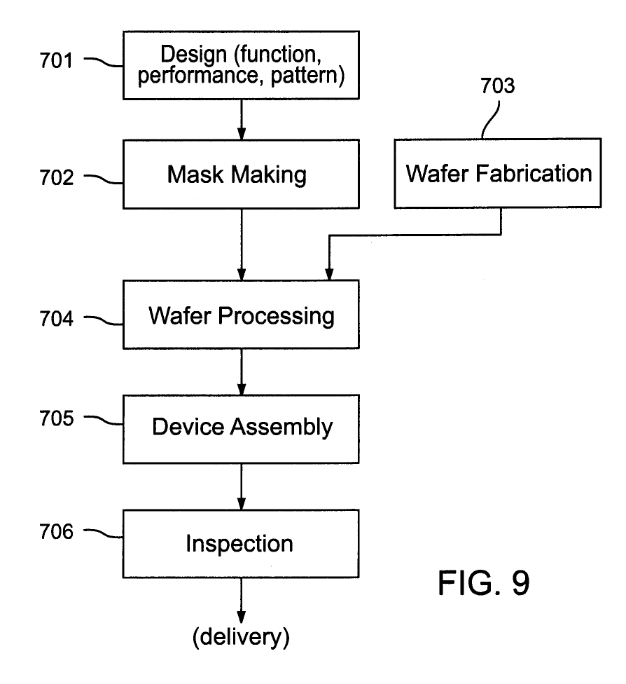

Semiconductor devices can be fabricated by processes including microlithography steps performed using a microlithography system as described above. Referring to FIG. 9, in step 701 the function and performance characteristics of the semiconductor device are designed. In step 702 a reticle defining the desired pattern is designed according to the previous design step. Meanwhile, in step 703, a substrate (wafer) is made and coated with a suitable resist. In step 704 the reticle pattern designed in step 702 is exposed onto the surface of the substrate using the microlithography system. In step 705 the semiconductor device is assembled (including “dicing” by which individual devices or “chips” are cut from the wafer, “bonding” by which wires are bonded to the particular locations on the chips, and “packaging” by which the devices are enclosed in appropriate packages for use). In step 706 the assembled devices are tested and inspected.

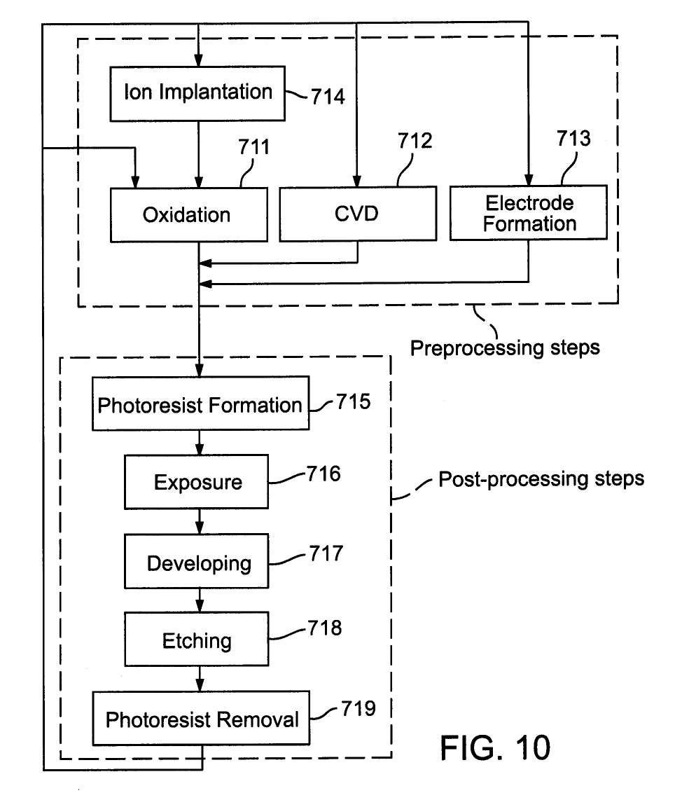

Representative details of a wafer-processing process including a microlithography step are shown in FIG. 10. In step 711 (oxidation) the wafer surface is oxidized. In step 712 (CVD) an insulative layer is formed on the wafer surface. In step 713 (electrode formation) electrodes are formed on the wafer surface by vapor deposition for example. In step 714 (ion implantation) ions are implanted in the wafer surface. These steps 711-714 constitute representative “pre-processing” steps for wafers, and selections are made at each step according to processing requirements.

At each stage of wafer processing, when the pre-processing steps have been completed, the following “post-processing” steps are implemented. A first post-process step is step 715 (photoresist formation) in which a suitable resist is applied to the surface of the wafer. Next, in step 716 (exposure), the microlithography system described above is used for lithographically transferring a pattern from the reticle to the resist layer on the wafer. In step 717 (development) the exposed resist on the wafer is developed to form a usable mask pattern, corresponding to the resist pattern, in the resist on the wafer. In step 718 (etching), regions not covered by developed resist (i.e., exposed material surfaces) are etched away to a controlled depth. In step 719 (photoresist removal), residual developed resist is removed (“stripped”) from the wafer.

Formation of multiple interconnected layers of circuit patterns on the wafer is achieved by repeating the pre-processing and post-processing steps as required. Generally, a set of pre-processing and post-processing steps are conducted to form each layer.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

What is claimed is:

1. An illumination device, comprising:
a source emitting a pulsed coherent light beam along a path, the beam having a transverse spatial coherence length and comprising multiple beam pulses;
a deflector positioned in the path and configured to spatially displace a first portion of a beam pulse from a second portion of the beam pulse, the second portion being later in time than the first portion; and
a diffuser situated in the path and configured to receive the first portion of the beam pulse on a first region of the diffuser and the second portion of the beam pulse on a second region of the diffuser, such that the first and second regions are separated by a distance at least equal to the transverse spatial coherence length.

2. The device of claim 1, further comprising a scan-amplifier situated between the deflector and the diffuser.

3. The device of claim 2, wherein the scan-amplifier comprises a near-confocal resonator cavity or a second deflector.

4. The device of claim 3, wherein:
the scan-amplifier comprises a second deflector; and
the second deflector comprises a moving mirror or electro-optical deflector.

5. The device of claim 1, wherein the deflector comprises an electro-optic deflector or moving mirror.

6. The device of claim 5, further comprising a scan-amplifier situated between the deflector and the diffuser.

7. The device of claim 6, wherein the scan-amplifier comprises a near-confocal resonator cavity or a second deflector.

8. The device of claim 1, wherein:
the deflector comprises a moving mirror impinged by the beam; and
the device further comprises a scan-amplifier situated between the deflector and the diffuser.

9. The device of claim 1, wherein the deflector comprises multiple moving mirrors impinged by the beam.

10. The device of claim 9, further comprising a scan-amplifier situated between the deflector and the diffuser.

11. The device of claim 1, wherein the deflector is configured to pass the laser beam multiple times through the deflector.

12. The device of claim 1, further comprising a wavelength-conversion system situated downstream of the source and upstream of the diffuser.

13. The device of claim 12, wherein the wavelength-conversion system is situated between the deflector and the diffuser.

14. The device of claim 1, wherein;
the diffuser is a first diffuser situated upstream of the deflector; and
the device further comprises a second diffuser situated downstream of the deflector.

15. The device of claim 1, further comprising an illumination-optical system downstream of the diffuser.

16. A device for producing a laser beam exhibiting reduced speckle, the device comprising:
a laser source emitting a pulsed laser beam along a path, the laser beam having a transverse spatial coherence length and comprising multiple beam pulses;
a deflector positioned in the path and configured to spatially displace a first portion of a beam pulse from a second portion of the beam pulse, the second portion being later in time than the first portion; and
a diffuser situated in the path and configured to receive the first portion of the beam pulse on a first region of the diffuser and the second portion of the beam pulse on a second region of the diffuser, such that the first and second regions are separated by a distance at least equal to the transverse spatial coherence length.

17. A device for reducing speckle in a pulsed laser beam having a transverse spatial coherence length, the device comprising:
a deflector positioned to receive beam pulses of the laser beam, the deflector being configured to spatially displace a first portion of a beam pulse from a second portion of the beam pulse, the second portion being later in time than the first portion; and
a diffuser situated and configured to receive the first portion of the beam pulse on a first region of the diffuser and the second portion of the beam pulse on a second region of the diffuser, such that the first and second regions are separated by a distance at least equal to the transverse spatial coherence length.

18. An illumination-optical system, comprising:
a laser source emitting a pulsed laser beam along a path, the laser beam having a transverse spatial coherence length and comprising multiple beam pulses;
a deflector positioned in the path and configured to spatially displace a first portion of a beam pulse from a second portion of the beam pulse, the second portion being later in time than the first portion; and
a diffuser situated in the path and configured to receive the first portion of the beam pulse on a first region of the diffuser and the second portion of the beam pulse on a second region of the diffuser, such that the first and second regions are separated by a distance at least equal to the transverse spatial coherence length.

19. The system of claim 18, further comprising at least one optical element located downstream of the diffuser.

20. A microlithography system, comprising:
an illumination system including (a) a laser source emitting a pulsed laser beam having a transverse spatial coherence length and comprising multiple beam pulses, (b) a deflector situated and configured to spatially displace a first portion of a beam pulse from a second portion of the beam pulse, the second portion being later in time than the first portion, and (c) a diffuser situated and configured to receive the first portion of the beam pulse on a first region of the diffuser and the second portion of the beam pulse on a second region of the diffuser, such that the first and second regions are separated by a distance at least equal to the transverse spatial coherence length; and
an imaging-optical system situated downstream of the illumination system.

21. An illumination device, comprising:
a laser source emitting a pulsed laser beam along a path, the beam having a transverse spatial coherence length and comprising at least one pulse having a pulse length;
a deflector positioned in the path and configured to deflect, at an angular velocity, pulses of the laser beam; and
a diffuser situated to receive deflected pulses from the deflector;
wherein the deflector moves the pulses across the diffuser at a velocity of motion related to the angular velocity, the velocity of motion is such that a mathematical product of the pulse length and the velocity of motion is at least as large as the transverse spatial coherence length.

22. The device of claim 21, wherein the deflector is an electro-optic deflector.

23. The device of claim 21, further comprising a scan-amplification system.

24. A microlithography system, comprising an illumination device as recited in claim 21.

25. A method for reducing speckle in a pulsed laser beam, comprising:
scanning a pulsed laser beam, having a transverse spatial coherence length and comprising at least one pulse with a pulse length, across a diffuser at a velocity of motion that is such that a mathematical product of the pulse length and the velocity of motion is at least as large as the transverse spatial coherence length; and
diffusing the scanned pulsed laser beam.

26. The method of claim 25, further comprising, before diffusing the scanned beam, amplifying an angle at which the pulsed laser beam is scanned

27. An illumination device, comprising:
a source means for emitting pulses of a pulsed laser beam, the pulsed laser beam having a transverse spatial coherence length;
displacement means for receiving the pulses and, with respect to a pulse, for spatially displacing a beginning portion of the pulse from a latter portion of the pulse; and
diffusing means including means for diffusing the beginning portion of the beam pulse and means for diffusing the latter portion of the beam pulse, the means for diffusing the beginning portion and the means for diffusing the latter portion being separated by a distance that is at least as long as the transverse spatial coherence length.
